(19) United States
(12) Patent Application Publication
(10) Pub. No.: US 2012/0118678 A1
(43) Pub. Date: May 17, 2012

(54) CODE STRIP FOR AN ELEVATOR INSTALLATION

(76) Inventor: Daniel Meierhans, Luzern (CH)

(21) Appl. No.: 13/293,572

(22) Filed: Nov. 10, 2011

(30) Foreign Application Priority Data
Nov. 16, 2010 (EP) 10191335.8

(51) Int. Cl. B66B 1/36

(52) U.S. Cl. 187/394

(57) ABSTRACT

A code strip has per meter a specific number of grid positions, which are provided in alternating sequence with openings and webs. A sensor can detect, for example, the travel direction of an elevator cage from the alternating sequence of the openings and webs. The code strip can be produced at, for example, the factory with alternating openings and webs per meter and adapted on site to the specific requirements of an elevator installation by breaking off the webs. Through breaking off the webs over a length a door zone, for example, is represented on the code strip.

### CROSS-REFERENCE TO RELATED APPLICATION

This application claims priority to European Patent Application No. 10191335.8, filed Nov. 16, 2010, which is incorporated herein by reference.

### FIELD

The disclosure relates to a code strip for an elevator installation.

### BACKGROUND

An elevator with a device for generating shaft information has become known from the patent specification U.S. Pat. No. 4,433,756, wherein an elevator cage is controllable in dependence on the shaft information in an elevator shaft. A code strip spanning the shaft height is provided with a coding, which is readable by means of a sensor device arranged at the elevator cage. The coding consists of openings arranged in two tracks. Each track is divided into a grid consisting of grid positions arranged one under the other, wherein a grid position is an opening or a web which is part of the code strip.

In a first track, a web follows each opening. On one side of the first track two light transmitters generating light beams are arranged. Associated with each light transmitter on the other side of the first track is a light receiver which receives the light beam passing through an opening and converts it into an electrical signal. The light beams of the two light transmitters are so spaced apart that when one light beam passes through an opening the other light beam impinges on an adjacent web and correspondingly is not recognized by the associated light receiver. The travel direction of the elevator cage is determinable from the signals of the two light receivers.

The sequence of the openings and webs is determined in a second track in accordance with a binary code, wherein depending on the respective information to be represented a specific number of grid positions is provided in different sequence with openings and/or webs. A light transmitter generating a light beam is arranged on one side of the second track. Associated with the light transmitter on the other side of the second track is a light receiver, which receives the light beam passing through an opening and converts it into an electrical signal The absolute position of the elevator cage is determinable from the signals of the light receiver.

The code strip with the coding is manufactured and finished at the factory and installed on site in the elevator shaft. In at least some cases, a corresponding code strip is required for every kind of elevator and for every conveying height.

### SUMMARY

In at least some embodiments, a standardized code strip is usable for different elevator installations with different controls and with different conveying heights. The code strip can in fact be produced with coding per meter and then adapted at least in part on site to the specific elevator installation and/or the building. With, for example, only one code strip for different elevator installations, production and warehousing can be more economic. The code strip can also enable adaptation of the coding to stories with unforeseeably excessive construction tolerances.

### BRIEF DESCRIPTION OF THE DRAWINGS

The present disclosure is explained in more detail by way of the accompanying figures, in which:

FIG. 1 shows an exemplary embodiment of an elevator installation with a device for generating shaft information,

FIG. 2 shows an exemplifying embodiment of a code strip,

FIG. 2a shows details of the code strip according to FIG. 2,

FIG. 3 shows a further exemplifying embodiment of a code strip,

FIG. 4 shows a section along the line A-A of FIG. 3,

FIG. 5 shows an exemplifying embodiment of a coding and

FIG. 6 shows a further exemplifying embodiment of a code strip.

### DETAILED DESCRIPTION

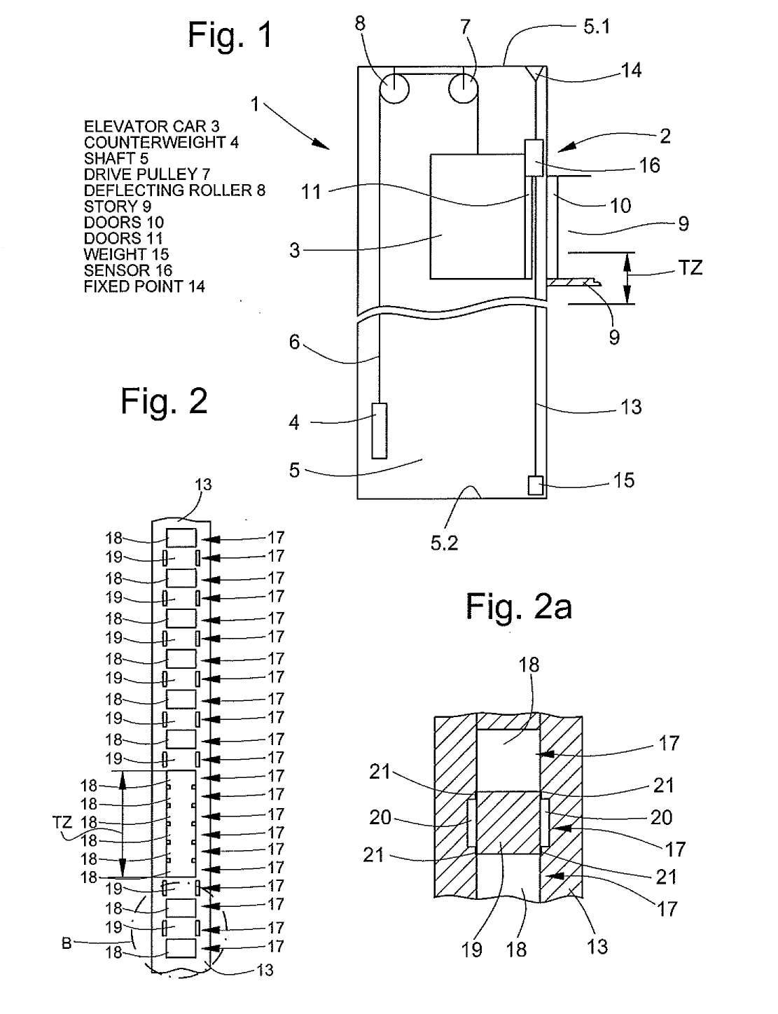

FIG. 1 shows, by way of example and schematically, an elevator installation 1 with a device 2 for generating shaft information. An elevator cage 3 and a counterweight 4 are movable in opposite directions in an elevator shaft 5. A support means 6 comprising, for example, steel cables, synthetic fiber cables, belts, etc., connects the elevator cage 3 with the counterweight 4 with a 1:1 support means guidance and is guided over a drive pulley 7 and a deflecting roller 8. A 2:1 or any support means guidance is also possible.

The elevator cage 3 is shown in FIG. 1 standing at a story 9. The elevator shaft 5 has further stories, which are not illustrated. When the shaft door 10 and cage door 11 are open, users of the elevator cage 3 can board and disembark. A door zone is denoted by TZ. When the elevator cage 3 travels from above or from below into the door zone TZ the door opening process for the story door 10 and the cage door 11 is initiated. The elevator cage 3 travels at reduced speed to the story level and the doors 10, 11 begin to open during the entry.

In the illustrated exemplifying embodiment of FIG. 1 a code strip 13 is arranged in the elevator shaft 5. One end of the cage strip 13 is arranged at a fixed point 14 of a shaft ceiling 5.1 and the other end of the code strip is arranged in a shaft pit 5.2 at a weight 15. Alternatively, one end of the code strip 13 can be fastened to a bracket arranged at a shaft wall and/or the other end of the code strip 13 can be tensioned in the shaft pit 5.2 by means of a spring. The code strip 13 extends, independently of the fastening, from above to below or vice versa. The code strip 13 can also be arranged only in specific sections of the elevator shaft 5.

A sensor 16 is arranged at the elevator cage 3. The sensor 16 moves together with the elevator cage 3 and travels over the code strip 13. In that case the sensor 16 recognizes a coding of the code strip 13 and generates electrical signals in correspondence with the coding. Alternatively, the sensor 16 can also be fixedly arranged in the elevator shaft 5 and the code strip 13 moved by means of the elevator cage 3 past the sensor 16. The sensor 16 can, for example, operate optically with a light transmitter/light receiver within or outside the visible light spectrum or operate inductively/capacitively with a proximity switch or operate with an image sensor.

FIG. 2 shows an exemplifying embodiment of the code strip 13. The code strip 13 has per meter a specific number of grid positions 17 which are provided in alternating sequence with openings 18 and webs 19. From the alternating sequence of openings 18 and webs 19 the sensor 16 can, for example, detect the travel direction of the elevator cage 3. In that case the light beams of two light transmitters are so spaced apart that when one light beam passes through an opening 18 the other light beam impinges on an adjacent web 19 and accordingly is not recognized by the associated light receiver. The travel direction of the elevator cage is determinable from the signals of the two light receivers.

Such a code strip 13 can be produced at, for example, the factory with alternating openings 18 and webs 19 per meter and, for example, adapted on site to the specific requirements of the elevator installation and the building by breaking off the webs 19. The door zone TZ is imaged on the code strip 13 by breaking off the webs 19 over a length TZ. If the sensor 16 detects such a zone during travel of the elevator cage 3 the opening process of the doors 10, 11 is, as mentioned above, initiated.

FIG. 2a shows a detail B of the code strip 13 according to FIG. 2. Each web 19 is provided with slots 20 for the breaking off and is separated at first frangible locations 21 from the code strip 13. The separation is carried out by means of tools or, if the frangible location 21 is perforated or notched, by manual pressing on the web 19 or, for example, by placing a suction cup on the web 19. The separation of a web 19 from the code strip 13 can also be reversed, for example, by means of spot-welding or soldering or another form of connection at any frangible location 21 between web 19 and code strip 13.

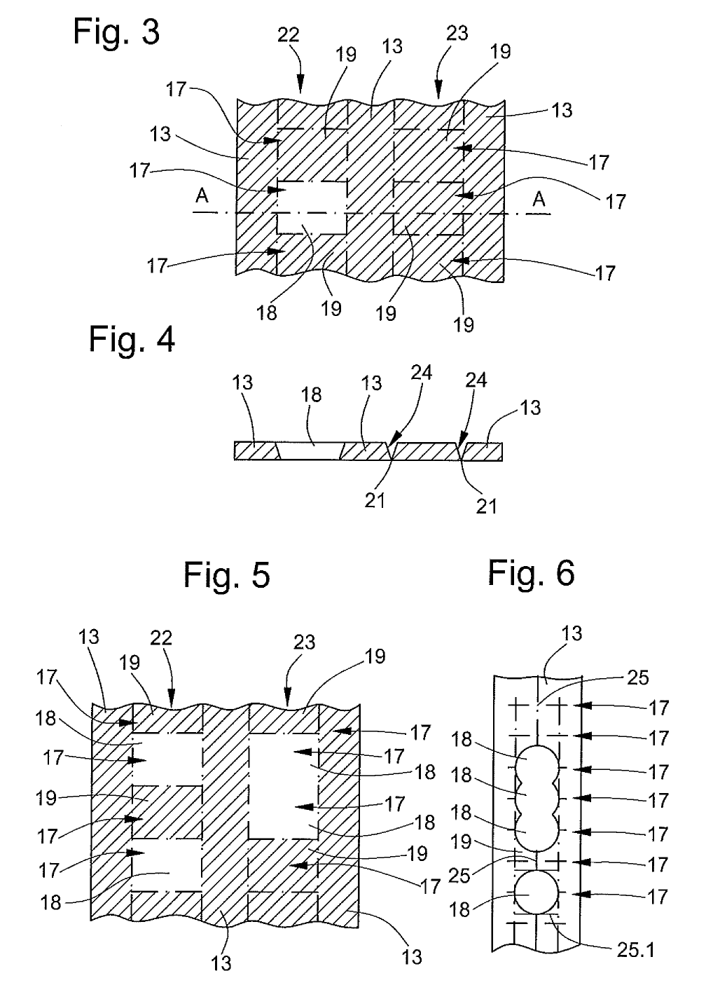

FIG. 3 shows a further exemplifying embodiment of the code strip 13 with a first track 22 and a second track 23. The associated sensor 16 is correspondingly of double or two-channel construction and can recognize the coding of the individual tracks 22, 23. Each track 22, 23 of the code strip 13 has a specific number of grid positions 17 per meter, wherein each grid position 17 is provided all round with notches 24. The grid positions 17 are at a time of delivery of the code strip 13 on site provided with webs 19 or with webs 19 and openings 18, wherein the coding determined by the webs 19 and openings is a standard coding. Depending on the respective elevator installation 1 and building, the grid positions 17 can be, for example, individually provided on site with openings. Through the notches 24 provided all round the grid positions 17 each web 19 can be easily removed by, for example, manually pressing on the web 19. The separation of a web 19 from the code strip 13 can also be made reversible, for example, by means of spot-welding or another form of connection along the notches 24 between web 19 and code strip 13. The grid positions 17 can also have other shapes, for example they can be circularly round. The code strip 13 can also comprise more than two tracks 22, 23.

FIG. 4 shows a section along the line A-A of FIG. 3 through an opening 18 of the first track 22 and a through a web 19 of the second track 23. The encircling notches 24 form frangible locations 21, along which the webs 19 are easily separable from the code strip 13.

FIG. 5 shows an exemplifying embodiment of a coding of the code strip 13 according to FIGS. 3 and 4. The first track 22 is provided with webs 19 and openings 18 arranged in alternating sequence and can, for example, be used as a coding of the travel direction of the elevator cage 3. In that case the light beams of two light transmitters are so spaced apart that when one light beam passes through an opening 18 the other light beam impinges on an adjacent web 19 and accordingly is not recognized by the associated light receiver. The travel direction of the elevator cage is determinable from the signals of the two light receivers. This coding can be produced, for example, at the factory as a standard coding. The second track 23 can be used for a coding adapted to the respective elevator installation 1 and the respective building and, for example, image the door zone TZ shown in FIG. 1. The second track 23 can also be used for a binary coding and/or, for example, contain the absolute position of the elevator cage 3.

A transparent code band 13 on which grid positions 17 are marked is also possible. For the coding, grid positions are left transparent or colored and made impermeable by the beams of the sensor 16. Colored grid positions correspond in their effect with the webs 19 mentioned further above and transparent grid positions correspond in their effect with the openings 18 mentioned further above.

FIG. 6 shows a further exemplifying embodiment of the code strip 13. In this code strip 13 reference points 25 are arranged on the code strip 13. The reference points 25, which are, for example, printed or pricked, serve as a reference for a tool for separating the webs 19 from the code strip 13 at the factory or on site. The grid positions 17 can be marked by means of reference lines 25.1 instead of the reference points 25 or additionally to the reference points 25.

The code strip 13 can be a steel strip or a plastics material strip.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. A code strip for an elevator installation, the code strip comprising a coding readable by at least one sensor, the coding being represented by a plurality of openings and webs arranged in a grid on the code strip, the webs comprising respective frangible locations for separation of the webs from the code strip,

2. The code strip of claim 1, the respective frangible locations being formed by respective notches.

3. The code strip of claim 1, further comprising reference points or reference lines, the reference points or reference lines marking a plurality of positions in the grid and serving as references for separation of the webs from the code strip.

4. The code strip of claim 1, the grid forming a single track of grid positions.

5. The code strip of claim 1, the grid forming multiple tracks of grid positions.

6. An elevator installation comprising:
at least one sensor; and
a code strip, the code strip comprising a coding readable by the at least one sensor, the coding being represented by a plurality of openings and webs arranged in a grid on the code strip, the webs comprising respective frangible locations for separation of the webs from the code strip.

7. An elevator code strip method, the method comprising removing one or more of a plurality of webs of a code strip, the plurality of webs being arranged in a grid on the code strip, the plurality of webs comprising respective frangible locations for separation of the one or more of the plurality of webs from the code strip, the removing of the one or more of the plurality of webs encoding on the code strip a value associated with a specific elevator installation and a specific building.

8. The elevator code strip method of claim 7, the respective frangible locations being formed by respective notches in the code strip.

9. The elevator code strip method of claim 7, the code strip further comprising reference points or reference lines, the reference points or reference lines marking a plurality of positions in the grid and serving as references for separation of the webs from the code strip.

10. The elevator code strip method of claim 7, the code strip having a default coding before the removal of the one or more of the plurality of webs from the code strip.
